(19) United States
(12) Patent Application Publication
(10) Pub. No.: US 2008/0213583 A1
(43) Pub. Date: Sep. 4, 2008

(54) Electrically-Conductive Laminated Film, Touch Panel Electrode Plate, Touch Panel, and Pressure-Sensitive Adhesive for Use in Electrically-Conductive Laminated Film

(75) Inventors: Tomonori Noguchi, Osaka (JP); Toshitsugu Hosokawa, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/794,267

(22) PCT Filed: Oct. 20, 2006
(86) PCT No.: PCT/JP2006/320950

§ 371 Date: Jun. 27, 2007

(30) Foreign Application Priority Data
Oct. 31, 2005 (JP) 2005-316576

(51) Int. Cl. B32B 7/12

(52) U.S. Cl. 428/355 AC

(57) ABSTRACT

An electrically-conductive laminated film of the invention comprises a first transparent substrate having first and second surfaces; an electrically-conductive film comprising a second transparent substrate having first and second surfaces and a transparent electrically-conductive thin layer provided on the first surface of the second transparent substrate; and a pressure-sensitive adhesive layer, wherein the first transparent substrate and the electrically-conductive film are arranged in such a manner that the second surface of the first transparent substrate is opposed to the second surface of the second transparent substrate, wherein the first transparent substrate and the electrically-conductive film are bonded to each other with the pressure-sensitive adhesive layer interposed therebetween; wherein each of the first and second transparent substrates is formed of a plastic material, wherein the pressure-sensitive adhesive layer is formed of a pressure-sensitive adhesive comprising an acrylic polymer comprising 1 to 35% by weight of a methyl (meth)acrylate monomer unit, 60 to 98% by weight of an alkyl (meth)acrylate monomer unit having an alkyl group of 2 to 12 carbon atoms, and 0.1 to 10% by weight of a functional group-containing monomer unit. The electrically-conductive laminated film can suppress to become the pressure-sensitive adhesive layer a pear skin appearance.

### TECHNICAL FIELD

The invention relates to an electrically-conductive laminated film including two transparent plastic substrates laminated with a pressure-sensitive adhesive layer interposed therebetween. The invention also relates to a touch panel electrode plate using the electrically-conductive laminated film. The invention also relates to a touch panel using the touch panel electrode plate and to a pressure-sensitive adhesive for use in forming the pressure-sensitive adhesive layer of the electrically-conductive laminated film.

### BACKGROUND ART

Among various types of touch panels, film resistive touch panels are frequently used in combination with liquid crystal displays in order to achieve a reduction in the thickness of liquid crystal displays or power saving of liquid crystal displays. Film resistive touch panels generally include a matrix type and an analog type, and they are properly used depending on the intended use. The matrix type includes strip-shaped electrodes that are formed in directions crossing each other on a press-side (input-side) substrate and a non-press-side (display side) substrate, respectively, and arranged opposite to each other with a spacer interposed therebetween.

The analog type touch panel includes electrically-conductive films having transparent electrically-conductive thin layers that are placed inside and arranged opposite to each other with a spacer interposed therebetween. The analog type touch panel is configured such that a current is fed through one of the transparent electrically-conductive thin layers, while the other transparent electrically-conductive thin layer is measured for voltage, and that when the opposed transparent electrically-conductive thin layers are brought into contact with each other by pressing operation with a finger, a pen or the like, the position is detected based on the current flow at the contact portion. Generally for current supply, leads made of an electrically-conductive paste such as a silver paste are provided on the end of the transparent electrically-conductive thin layers. For example, the leads are formed by a process that includes heating, at 100 to 150° C. for 1 to 2 hours, an electrically-conductive paste interposed between the transparent electrically-conductive thin layers to cure it, while keeping the surfaces of the opposed electrically-conductive films flat.

Concerning the electrically-conductive film, there is proposed an electrically-conductive laminated film in which a transparent substrate (a hard-coated film) having a hard coat layer at its outer surface is laminated on an electrically-conductive film including a transparent substrate and a transparent electrically-conductive thin layer provided on one side of the transparent substrate with a pressure-sensitive adhesive layer therebetween, such that the electrically-conductive laminated film can withstand scratching or taps during pressing operation (see Patent Literature 1).

Plastic substrates are generally used as the transparent substrate for the electrically-conductive laminated film. However, there is a problem in which oligomer components of the plastic material forming the transparent substrate of the electrically-conductive film can move to the pressure-sensitive adhesive layer bonding the transparent substrates to each other by the curing process; thereby the pressure-sensitive adhesive layer becomes a pear skin appearance. If the electrically-conductive laminated film having such a pear skin pressure-sensitive adhesive layer is used to form a touch panel, the visibility of the screen can be degraded.

In order to solve the problem with the pressure-sensitive adhesive layer in the electrically-conductive laminated film, it is proposed that an anti-diffusion layer made of an inorganic or organic material is placed between the pressure-sensitive adhesive layer and the transparent substrate of the electrically-conductive film such that the diffusion of oligomers from the transparent substrate to the pressure-sensitive adhesive layer can be prevented (see Patent Literature 2). However, the formation of the anti-diffusion layer can increase the number of the processes for manufacturing the electrically-conductive laminated film and also increase the total thickness of the electrically-conductive laminated film, which would otherwise be required to have a reduced thickness.

### Patent Literature 1: Japanese Patent No. 2667686

### Patent Literature 2: Patent Application Laid-Open (JP-A) No. 2002-103504

### DISCLOSURE OF THE INVENTION

### Problems to be Solved by the Invention

It is an object of the invention to provide an electrically-conductive laminated film in which an electrically-conductive film including a transparent plastic substrate and a transparent electrically-conductive thin layer provided on one side of the substrate is laminated on another transparent substrate with a pressure-sensitive adhesive layer interposed therebetween and in which the pressure-sensitive adhesive layer can be prevented from becoming a pear skin appearance.

It is another object of the invention to provide a touch panel electrode plate using the electrically-conductive laminated film and to provide a touch panel using the touch panel electrode plate. It is a further object of the invention to provide a pressure-sensitive adhesive for use in forming the pressure-sensitive adhesive layer of the electrically-conductive laminated film.

### Means for Solving the Problems

As a result of active investigations for solving the problems, the inventors have found that the objects can be achieved with the electrically-conductive laminated film described below, so that the invention has been completed.

The present invention relates to an electrically-conductive laminated film, comprising:
a first transparent substrate having first and second surfaces;
an electrically-conductive film comprising a second transparent substrate having first and second surfaces and a transparent electrically-conductive thin layer provided on the first surface of the second transparent substrate; and
a pressure-sensitive adhesive layer,
wherein the first transparent substrate and the electrically-conductive film are arranged in such a manner that the second surface of the first transparent substrate is opposed to the second surface of the second transparent substrate,
wherein the first transparent substrate and the electrically-conductive film are bonded to each other with the pressure-sensitive adhesive layer interposed therebetween;
wherein each of the first and second transparent substrates is formed of a plastic material,
wherein the pressure-sensitive adhesive layer is formed of a pressure-sensitive adhesive comprising an acrylic polymer comprising 1 to 35% by weight of a methyl (meth)acrylate monomer unit, 60 to 98% by weight of an alkyl (meth)acrylate monomer unit having an alkyl group of 2 to 12 carbon atoms, and 0.1 to 10% by weight of a functional group-containing monomer unit.

In the electrically-conductive laminated film, the acrylic polymer preferably comprises 1 to 28% by weight of the methyl (meth)acrylate monomer unit, 65 to 98% by weight of the alkyl (meth)acrylate monomer unit having an alkyl group of 2 to 12 carbon atoms, and 0.1 to 10% by weight of the functional group-containing monomer unit.

In the electrically-conductive laminated film, the functional group-containing monomer is preferably a carboxyl group-containing monomer.

In the electrically-conductive laminated film, the pressure-sensitive adhesive preferably contains a crosslinking agent.

In the electrically-conductive laminated film, the pressure-sensitive adhesive preferably contains a silane coupling agent.

In the electrically-conductive laminated film, the first transparent substrate may comprise a hard coat layer provided on the first surface thereof.

In the electrically-conductive laminated film, the first and second transparent substrates are preferably each formed of a polyester resin.

The present invention also relates to a touch panel electrode plate, comprising the above electrically-conductive laminated film.

The present invention also relates to a touch panel, comprising a pair of touch panel electrode plates that each have a transparent electrically-conductive thin layer and are arranged opposite to each other with a spacer interposed therebetween in such a manner that the transparent electrically-conductive thin layers are opposed to each other, wherein at least one of the touch panel electrode plates is the above touch panel electrode plate.

The present invention also relates to a pressure-sensitive adhesive for use in forming the pressure-sensitive adhesive layer of the above electrically-conductive laminated film, comprising an acrylic polymer comprising 1 to 35% by weight of a methyl (meth)acrylate monomer unit, 60 to 98% by weight of an alkyl (meth)acrylate monomer unit having an alkyl group of 2 to 12 carbon atoms, and 0.1 to 10% by weight of a functional group-containing monomer unit.

### Effect of the Invention

In electrically-conductive laminated films, for example, acrylic pressure-sensitive adhesives, silicone pressure-sensitive adhesives, rubber-based pressure-sensitive adhesives or the like have been used to bond first and second transparent substrates. In particular, acrylic pressure-sensitive adhesives have been used. In general, acrylic polymers for use as base polymers in acrylic pressure-sensitive adhesives comprise a monomer unit of alkyl (meth)acrylate having an alkyl group of 4 or more carbon atoms as a main component and also comprise a functional group-containing monomer as a copolymerized component for imparting polarity. In contrast, methyl (meth)acrylate, which is of one-carbon alkyl type, has not been used for acrylic polymers of pressure-sensitive adhesives, because as compared with other alkyl (meth)acrylates, it has a high solubility parameter and a high glass transition point, less contributes to adhesive performance, and hardly functions as a crosslinking point when a crosslinking agent is used, although it has polarity.

It has been found that if methyl (meth)acrylate, which has generally not been used as a monomer unit as mentioned above, is used as a monomer unit together with another alkyl (meth)acrylate and a functional group-containing monomer to form an acrylic polymer and if an acrylic pressure-sensitive adhesive containing such an acrylic polymer is used to form a pressure-sensitive adhesive layer of an electrically-conductive laminated film according to the invention, the pressure-sensitive adhesive layer can be prevented from being a pear skin appearance. It is believed that if the acrylic polymer includes the methyl (meth)acrylate monomer unit, oligomer components can be prevented from moving from the transparent plastic substrate to the pressure-sensitive adhesive layer, or the methyl (meth)acrylate unit in the pressure-sensitive adhesive layer can prevent the formation of a pear skin appearance even though oligomer components move to the pressure-sensitive adhesive layer.

In the electrically-conductive laminated film of the invention, therefore, the problem of the pear skin appearance can be prevented by the monomer unit composition of the acrylic pressure-sensitive adhesive forming the pressure-sensitive adhesive layer and an increase in the number of manufacturing processes or an increase in total thickness due to the additional formation of an anti-diffusion layer can be avoided.

In the electrically-conductive laminated film of the invention, the pressure-sensitive adhesive layer can be suppressed to being a pear skin appearance because of the pressure-sensitive adhesive layer formed of an acrylic pressure-sensitive adhesive including an acrylic polymer containing a methyl (meth)acrylate monomer unit, but if the methyl (meth)acrylate monomer unit is too much, spherical foams can be sometimes generated in the pressure-sensitive adhesive layer when the electrically-conductive laminated film is subjected to a curing process by heating. In the electrically-conductive laminated film of the invention, therefore, the content of the methyl (meth)acrylate monomer unit in the acrylic polymer is controlled so that such heat-induced foaming can be suppressed.

### BRIEF DESCRIPTION OF DRAWINGS

FIG. 1 is a cross-sectional view showing an example of the electrically-conductive laminated film of the invention;

FIG. 2 is a cross-sectional view showing another example of the electrically-conductive laminated film of the invention; and

FIG. 3 is a cross-sectional view showing an example of the touch panel using the electrically-conductive laminated film of the invention.

### DESCRIPTION OF REFERENCE MARKS

In the drawings, reference mark 1 represents a first transparent substrate, 2 a second transparent substrate, 3 a transparent electrically-conductive thin layer, 4 a pressure-sensitive adhesive layer, and 5 a hard coat layer.

### BEST MODE FOR CARRYING OUT THE INVENTION

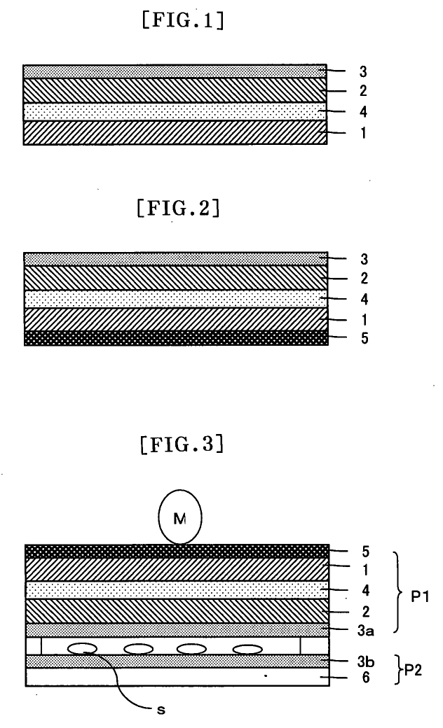

The electrically-conductive laminated film of the invention is described below with reference to FIGS. 1 and 2. Referring to FIG. 1, an electrically-conductive laminated film includes a first transparent substrate 1, an electrically-conductive film including a second transparent substrate 2 and a transparent electrically-conductive thin layer 3 provided on one side of the second transparent substrate 2, and a pressure-sensitive adhesive layer 4 with which the first substrate 1 and the electrically-conductive film are bonded to each other. A second surface of the first transparent substrate 1 is bonded to a second surface of the second transparent substrate 2 with the pressure-sensitive adhesive layer 4. In the electrically-conductive film, the transparent electrically-conductive thin layer 3 is provided on a first surface of the second transparent substrate 2. In FIG. 2, a hard coat layer 5 is provided on a first surface of the first transparent substrate 1.

A plastic substrate is used as each of the first and second transparent substrates. Any appropriate plastic material such as polyester resins, polyamide resins, polyvinyl chloride resins, polystyrene resins, and olefin resins such as polyethylenes and polypropylenes may be used as the plastic material for the transparent substrate. These materials to be used may be a stretched product. In particular, when polyester resins, specifically polyethylene terephthalate, is used, oligomers in the plastic material can easily migrate to the pressure-sensitive adhesive layer, and the invention is preferably applied to the case where such a plastic material is used.

While the thicknesses of the first and second transparent substrates may be determined as appropriate, in general, they are preferably from about 3 to 300 μm, more preferably from 5 to 250 μm, particularly preferably from 10 to 200 μm, in view of workability in the process of forming a touch panel, performance or the like.

The film thicknesses of the first and second transparent substrates are each preferably selected such that the former is thicker than the latter. The first transparent substrate generally has a thickness of about 50 to 300 μm, preferably of 75 to 200 μm, and the second transparent substrate generally has a thickness of about 3 to 100 μm, preferably of 10 to 50 μm. In these ranges, the film thicknesses of the first and second transparent substrates are preferably selected such that the former is thicker than the latter.

The electrically-conductive film is obtained by forming a transparent electrically-conductive thin layer on one side of the second transparent substrate. When the transparent electrically-conductive thin layer is formed, an appropriate method may be selected from various thin-layer formation methods such as vacuum deposition, sputtering, ion plating, spray thermal decomposition, chemical plating, electroplating, and any combination thereof, and used to form a film composed of a transparent electrically-conductive thin layer-forming material on a film of the second transparent substrate. In view of transparent electrically-conductive thin layer-forming speed, large area film-forming capability, productivity, and so on, vacuum deposition or sputtering is preferably used as the thin-layer formation method.

Any appropriate material capable of forming a transparent electrically-conductive layer may be selected and used as the transparent electrically-conductive thin layer-forming material. For example, metals such as gold, silver, platinum, palladium, copper, aluminum, nickel, chromium, titanium, iron, cobalt, tin, and alloys thereof, metal oxides such as indium oxide, tin oxide, titanium oxide, cadmium oxide, and mixtures thereof, or other metal compounds such as copper iodide are preferably used. The transparent electrically-conductive thin layer may be a crystalline layer or a non-crystalline layer.

The thickness of the transparent electrically-conductive thin layer may be determined as appropriate depending on the intended use and is generally from 10 to 300 nm, preferably from 10 to 200 nm. A thickness of less than 10 nm can make it difficult to form a highly-conductive continuous coating with a surface electric resistance of 10³ Ω/square or less, while if the thickness is too large, a reduction in transparency or the like can easily occur.

Although not shown in FIG. 1 or 2, the transparent electrically-conductive thin layer 3 may be formed on the first surface of the second transparent substrate with an anchor layer interposed therebetween. One or more anchor layers may be provided. The anchor layer may be made of an inorganic material, an organic material or a mixture of inorganic and organic materials. The formation of the anchor layer can improve adhesion between the second transparent substrate and the transparent electrically-conductive thin layer and is effective in improving the scratch resistance or bending resistance of the transparent electrically-conductive thin layer and in improving tap properties for touch panels.

For example, such an inorganic material as SiO₂, MgF₂ or Al₂O₃ is preferably used to form the anchor layer. Examples of the organic material include acrylic resins, urethane resins, melamine resins, alkyd resins, and siloxane polymers. In particular, a thermosetting resin comprising a mixture of a melamine resin, an alkyd resin and an organosilane condensate is preferably used as the organic material.

The anchor layer may be formed with any of the above materials by vacuum deposition, sputtering, ion plating, coating, or the like.

The anchor layer generally has a thickness of 100 nm or less, preferably of about 15 to 100 nm, more preferably of 20 to 60 nm.

When the transparent electrically-conductive thin layer is formed, the film surface of the second transparent substrate may also be subjected to appropriate adhesion treatment such as corona discharge treatment, ultraviolet irradiation treatment, plasma treatment, and sputtering etching treatment, so that the adhesion to the transparent electrically-conductive thin layer can be increased.

The hard coat layer may be formed by subjecting the first surface of the first transparent substrate to a hard coating process. For example, the hard coating process may be performed by a method of applying and curing a hard resin such as acrylic urethane resins and a siloxane resins. In the hard coating process, silicone resins or the like may also be added to the hard resin such as the acrylic urethanes or siloxane resins to form a roughened surface so that a non-glare surface capable of preventing glare, which would otherwise be caused by mirror effect in practical use as a touch panel or the like, can be formed at the same time.

If the hard coat layer being formed is thin, its hardness can be insufficient, while if the hard coat layer being formed is too thick, cracking can occur in some cases. Also taking curl preventing properties into account, the thickness of the hard coat layer is preferably from about 0.1 to 30 μm.

In the electrically-conductive laminated film of the invention, the pressure-sensitive adhesive layer for bonding the first and second transparent substrates is formed of a pressure-sensitive adhesive containing an acrylic polymer including a methyl (meth)acrylate monomer unit, an alkyl (meth)acrylate monomer unit having an alkyl group of 2 to 12 carbon atoms, and a functional group-containing monomer unit.

As used herein, the term “(meth)acrylate” refers to acrylate and/or methacrylate, and “meth” has the same meaning herein.

The alkyl (meth)acrylate having an alkyl group of 2 to 12 carbon atoms may be any of a straight chain and a branched chain. Examples thereof include ethyl (meth)acrylate, propyl (meth)acrylate, n-butyl (meth)acrylate, isobutyl (meth)acrylate, pentyl (meth)acrylate, isoamyl (meth)acrylate, hexyl (meth)acrylate, heptyl (meth)acrylate, 2-ethylhexyl (meth)acrylate, isooctyl (meth)acrylate, isononyl (meth)acrylate, and isomyristyl (meth)acrylate. The average number of the carbon atoms in the alkyl group of the alkyl (meth)acrylate is preferably from 4 to 8. In particular, n-butyl acrylate is preferred in view of adhesion. These alkyl (meth)acrylates may be used alone or in combination of two or more thereof.

For example, the functional group-containing monomer may be a carboxyl group-containing monomer. Examples thereof include acrylic acid, methacrylic acid, itaconic acid, and maleic acid. In particular, acrylic acid and methacrylic acid are preferably used.

The functional group-containing monomer may also be a hydroxyl group-containing monomer. Examples thereof include 2-hydroxyethyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)-methyl acrylate, and 2-methyl-3-hydroxypropyl (meth)acrylate.

Examples of functional group-containing monomers other than the above include epoxy group-containing monomers such as glycidyl (meth)acrylate, methylglycidyl (meth)acrylate, and 3,4-epoxycyclohexylmethyl (meth)acrylate; sulfonic acid group-containing monomers; phosphoric acid group-containing monomers; vinyl ester monomers; amide group-containing monomers; amino group-containing monomers such as dimethylaminomethylacrylamide; imide group-containing monomers; N-acryloylmorpholine; and vinyl ether monomers.

Among the above functional group-containing monomers, carboxyl group-containing monomers and hydroxyl group-containing monomers are preferably used, because they can improve adhesion and increase the number of crosslinking points to allow efficient crosslinking so that heat resistance can be improved. In view of polar components for achieving adhesion to objects, carboxyl group containing-monomers are particularly preferred.

The contents of the respective monomer units are as follows: 1 to 35% by weight of methyl (meth)acrylate; 60 to 98% by weight of alkyl (meth)acrylate having an alkyl group of 2 to 12 carbon atoms; and 0.1 to 10% by weight of the functional group-containing monomer.

If the content of the methyl (meth)acrylate monomer unit is less than 1% by weight, it will be difficult to prevent the pressure-sensitive adhesive layer from being a pear skin appearance. On the other hand, too much methyl (meth)acrylate is not preferred in order to prevent foaming during heating. From these points of view, the content of the methyl (meth)acrylate monomer unit is preferably from 1 to 28% by weight, more preferably from 5 to 25% by weight, still more preferably from 10 to 20% by weight.

In order to maintain the adhesion properties of the pressure-sensitive adhesive layer, particularly in order to maintain wettability to adherents, the content of the alkyl (meth)acrylate monomer unit having an alkyl group of 2 to 12 carbon atoms is preferably from 60 to 98% by weight, more preferably from 65 to 98% by weight, still more preferably from 70 to 90% by weight, yet more preferably from 75 to 85% by weight.

The content of the functional group-containing monomer unit is preferably from 0.1 to 10% by weight, more preferably from 0.5 to 8% by weight, still more preferably from 1 to 7% by weight, yet more preferably from 2 to 5% by weight, in order to impart polarity to the pressure-sensitive adhesive or in order to introduce crosslinking points for the use of a crosslinking agent, or in view of water absorption rate and the like.

The acrylic polymer may contain any other monomer unit copolymerizable with any of the above monomers. Examples of such a copolymerizable monomer include methoxyethyl (meth)acrylate, ethoxymethyl (meth)acrylate, (meth)acrylamide, vinyl acetate, (meth)acrylonitrile; styrene monomers such as styrene and α-methylstyrene; vinyltoluene monomers such as vinyltoluene; and benzyl (meth)acrylate, naphthyl (meth)acrylate, phenoxyethyl (meth)acrylate, and phenoxybutyl (meth)acrylate. These copolymerizable monomers may be used as long as the objects of the invention are not impaired, and the content of such a monomer unit is generally 30% by weight or less, preferably 20% by weight or less, more preferably 10% by weight or less.

The weight average molecular weight of the acrylic polymer according to the invention may be, but not limited to, 600,000 or more, preferably from 700,000 to 3,000,000. If the weight average molecular weight is less than 600,000, it can tend to have low durability. On the other hand, in view of workability, the weight average molecular weight is preferably 3,000,000 or less.

For the production of the acrylic polymer according to the invention, any appropriate method may be selected from known methods such as solution polymerization, bulk polymerization, and emulsion polymerization. In the solution polymerization, for example, ethyl acetate, toluene or the like is used as a polymerization solvent. A specific process of solution polymerization may include adding 0.01 to 0.2 parts by weight of a polymerization initiator such as azobisisobutyronitrile to 100 parts by weight of the total of the monomers and performing solution polymerization generally under a stream of nitrogen gas at about 50° C. to 70° C. for 8 to 30 hours. In the case of emulsion polymerization, an appropriate emulsifying agent or the like may be selected and used in addition to a polymerization initiator. A chain transfer agent may also be used in the polymerization. The molecular weight of the acrylic polymer can be adjusted as appropriate using the chain transfer agent. There is no particular limitation to the emulsifying agent or the chain transfer agent.

The pressure-sensitive adhesive of the invention may also contain a crosslinking agent in addition to the acrylic polymer. If the crosslinking agent is added, the pressure-sensitive adhesive may be crosslinked to have improved heat resistance (the effect of preventing heating-induced foaming).

Any crosslinking agent having reactivity with the functional group of the acrylic polymer is preferably used. Examples of the crosslinking agent include peroxides, isocyanate crosslinking agents, epoxy crosslinking agents, metal chelate crosslinking agents, melamine crosslinking agents, aziridine crosslinking agents, and metal salts. Alternatively, ultraviolet rays or electron beams may be used to crosslink the pressure-sensitive adhesive. These crosslinking agents may be used alone or in combination of two or more thereof. Among these crosslinking agents, isocyanate crosslinking agents are preferred in view of adhesion.

Examples of the isocyanate crosslinking agent include diisocyanates such as tolylene diisocyanate, diphenylmethane diisocyanate, xylylene diisocyanate, isophorone diisocyanate, and hexamethylene diisocyanate; diisocyanate adducts modified with various polyols; and polyisocyanate compounds in which an isocyanurate ring, a biuret structure, or an allophanate structure is formed. Since in some cases, aromatic isocyanate compounds can cause coloration of the pressure-sensitive adhesive layer after curing, an aliphatic or alicyclic isocyanate compound is preferably used as the isocyanate crosslinking agent in applications requiring transparency.

If the amount of the crosslinking agent is too large, excessive crosslinking can occur to degrade the adhesive properties. Thus, the amount of the crosslinking agent is generally 5 parts by weight or less, preferably from 0.01 to 5 parts by weight, more preferably from 0.1 to 3 parts by weight, based on 100 parts by weight of the acrylic polymer.

The pressure-sensitive adhesive of the invention may also contain a silane coupling agent. The addition of the silane coupling agent can improve the moisture resistance of the pressure-sensitive adhesive.

Examples of the silane coupling agent include epoxy structure-possessing silane coupling agents such as 3-glycidoxypropyltrimethoxysilane, 3-glycidoxypropylmethyldimethoxysilane, and 2-(3,4-epoxycyclohexyl)ethyltrimethoxysilane; amino group-containing silane coupling agents such as 3-aminopropyltrimethoxysilane, N-(2-aminoethyl)3-aminopropyltrimethoxysilane, N-(2-aminoethyl)3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; isocyanate group-containing silane coupling agents such as 3-isocyanatepropyltriethoxysilane; 3-chloropropyltrimethoxysilane; and acetoacetyl group-containing trimethoxysilane. A single silane coupling agent may be used alone, or a mixture of two or more silane coupling agents may be used.

If the amount of the silane coupling agent is too large, the adhesive strength to the transparent substrate can be increased too much to degrade re-peelability. Thus, the amount of the silane coupling agent is preferably from 2 parts by weight or less, more preferably from 0.01 to 2 parts by weight, still more preferably from 0.02 to 1 part by weight, based on 100 parts by weight of the acrylic polymer.

The pressure-sensitive adhesive of the invention may also contain any other known additive. For example, a tackifier, a colorant, a powder such as a pigment, a dye, a surfactant, a plasticizer, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use.

The pressure-sensitive adhesive of the invention may be used in the form of a solution. Examples of the solvent to be used include methyl ethyl ketone, acetone, ethyl acetate, tetrahydrofuran, dioxane, cyclohexanone, n-hexane, toluene, xylene, methanol, ethanol, n-propanol, isopropanol, and water. These solvents may be used alone, or two or more of these solvents may be mixed. A polymerization solvent may be used as it is, or otherwise one or more solvents other than the polymerization solvent may be further added such that the pressure-sensitive adhesive layer can be uniformly formed.

The pressure-sensitive adhesive is applied onto a supporting material and dried to form a pressure-sensitive adhesive layer. When the pressure-sensitive adhesive contains a crosslinking agent, crosslinking is appropriately performed by heat treatment or the like. The crosslinking process may be performed at the temperature of the solvent drying process or separately performed after the drying process.

The pressure-sensitive adhesive layer may be formed by any method. For example, the pressure-sensitive adhesive layer may be obtained by forming a layer composed of the pressure-sensitive adhesive on one or both sides of a supporting material such as a release-treated separator and then heat-treating the layer. The crosslinking process may be performed at the temperature of the process of drying the layer-forming solvent or may be separately performed after the drying process. The resulting pressure-sensitive adhesive layer is then bonded to the first or second transparent substrate. Alternatively, the pressure-sensitive adhesive layer may be obtained directly on the first or second transparent substrate by applying the pressure-sensitive adhesive to the first or second transparent substrate and then heat-treating it. Thereafter, the resulting pressure-sensitive adhesive layer may be subjected to an aging process for the purpose of controlling the crosslinking reaction of the pressure-sensitive adhesive layer.

After the first and second transparent substrates are bonded, the pressure-sensitive adhesive layer has the function of improving the scratch resistance of the transparent electrically-conductive thin layer formed on one side of the second transparent substrate or improving the tap properties thereof for touch panels, because of its cushion effect. In order that this function may be performed better, the elastic modulus of the pressure-sensitive adhesive layer is preferably set in the range of 1 to 100 N/cm², and the thickness thereof is set at 1 μm or more, generally in the range of 5 to 500 μm, preferably in the range of 5 to 10 μm.

If the elastic modulus of the pressure-sensitive adhesive layer is less than 1 N/cm², the pressure-sensitive adhesive layer can be inelastic so that it can be easily deformed by pressing and thus irregularities can be formed on the film substrate and then on the transparent electrically-conductive thin layer, and protrusion of the pressure-sensitive adhesive from a cut section can easily occur, and the effect of improving the scratch resistance of the transparent electrically-conductive thin layer or improving the tap properties thereof for touch panels can be reduced. If it exceeds 100 N/cm², the pressure-sensitive adhesive layer can be so hard that its cushion effect cannot be expected, and it can be impossible to improve the scratch resistance of the transparent electrically-conductive thin layer or to improve the tap properties thereof for touch panels.

If the thickness of the pressure-sensitive adhesive layer is less than 1 μm, its cushion effect cannot be expected so that an improvement in the scratch resistance of the transparent electrically-conductive thin layer or an improvement in the tap properties thereof for touch panels cannot be expected. If the pressure-sensitive adhesive layer is too thick, transparency can be reduced, or it can be difficult to obtain good results with respect to the formation of the pressure-sensitive adhesive layer or the workability of the lamination of the transparent substrates or with respect to cost.

The electrically-conductive laminated film of the invention is preferably used to form various devices such as touch panels and liquid crystal displays. In particular, it is preferably used for a component or part to be in contact with the outside, such as a touch panel, because it has undergone a hard coating process.

FIG. 3 shows an example of the touch panel using the electrically-conductive laminated film of the invention. Specifically, the touch panel includes a pair of panel plates (touch panel electrode plates) P1 and P2 that have transparent electrically-conductive thin layers 3a and 3b, respectively, and are arranged with spacers s interposed therebetween in such a manner that the transparent electrically-conductive thin layers 3a and 3b arranged perpendicular to each other are opposed to each other, in which the electrically-conductive laminated film described above and shown in FIG. 1 is used to form one of the panel plate P1.

This touch panel functions as a transparent switch structure in which when an input pen M is tapped on the panel plate P1 side, the transparent electrically-conductive thin layers 3a and 3b come into contact with each other to turn an electric circuit to the ON state, while removal of the press turns it to the original OFF state. In this mechanism, the panel plate P1 comprises the above-described electrically-conductive laminated film so that the formation of striped portions can be prevented in the transparent electrically-conductive thin layer.

While the panel plate P2 shown in FIG. 3 includes a transparent substrate 6 made of a plastic film, a glass plate or the like and a transparent electrically-conductive thin layer 3b provided on the substrate 6, an electrically-conductive laminated film having the same structure as the panel plate P1 shown in FIG. 1 may be used instead.

### EXAMPLES

The invention is described in detail with the examples below, which are not intended to limit the scope of the invention. In each example, the term “part or parts” means part or parts by weight.

### Example 1

### (Preparation of Acrylic Polymer)

Five parts of methyl acrylate, 93 parts of n-butyl acrylate, 2 parts of acrylic acid, and 0.1 parts of 2,2′-azobisisobutyronitrile were added to ethyl acetate in a reactor vessel equipped with a cooling tube, a nitrogen introducing tube, a thermometer, and a stirrer. The mixture was adjusted to have a solids content of 30% by weight, and after substitution with nitrogen gas, the mixture was heated to 55° C. and subjected to a polymerization reaction for 15 hours to give a solution of an acrylic polymer with a weight average molecular weight of 1,800,000.

### (Preparation of Acrylic Pressure-Sensitive Adhesive)

Based on 100 parts of the solid of the acrylic polymer, 0.1 parts of trimethylolpropanetolylene diisocyanate for serving as a crosslinking agent and 0.1 parts of 3-glycidoxypropyltrimethoxysilane for serving as a silane coupling agent were added to the acrylic polymer solution and uniformly mixed to form an acrylic pressure-sensitive adhesive according to the invention.

### (Preparation of Hard-Coated Film)

A 125 μm-thick and 1000 mm-wide polyethylene terephthalate film (Product No. F17 manufactured by Teijin DuPont Films Japan Limited) was provided as a first transparent substrate, and one side of the film was coated with a toluene solution prepared by adding 5 parts of hydroxycyclohexyl phenyl ketone (Irgacure 184 (trade name) manufactured by Ciba Specialty Chemicals Inc.) for serving as a photopolymerization initiator to 100 parts of an acrylic urethane resin (Unidic U4005 (trade name) manufactured by Dainippon Ink and Chemicals, Incorporated) and diluting the mixture to a concentration of 50% by weight. The coating was dried at 100° C. for 3 minutes and then immediately irradiated with ultraviolet light from two ozone-type high-pressure mercury lamps (each 80 W/cm, 15 cm focused radiation) to form a 5 μm-thick hard coat layer so that a hard-coated film was prepared.

### (Preparation of Electrically-Conductive Laminated Film)

The pressure-sensitive adhesive was applied to the second surface (hard coat layer-free surface) of the hard-coated film and dried at 150° C. for 5 minutes to form a 23 μm-thick pressure-sensitive adhesive layer, onto which the second surface (the transparent electrically-conductive thin layer-free surface) of the electrically-conductive film was bonded so that an electrically-conductive laminated film was prepared.

### Examples 2 to 4 and Comparative Example 1

Acrylic polymers were prepared using the process of Example 1, except that the contents of methyl acrylate, n-butyl acrylate and acrylic acid were changed as shown in Table 1. Acrylic pressure-sensitive adhesives and electrically-conductive laminated films were prepared using the process of Example 1, except that the resulting acrylic polymers were used instead.

### (Experiments for Evaluation)

The electrically-conductive laminated film (sample) obtained in each example was evaluated as described below. The results are shown in Table 1.

### (Determination of Oligomer in Pressure-Sensitive Adhesive Layer)

Each sample was heated under the conditions of 150° C. and 1 hour or 160° C. and 1 hour in a heating oven and then allowed to stand in a constant-temperature, high-humidity chamber (under an atmosphere at 60° C. and 95% RH) for 240 hours. The sample was then taken out and observed with a transmission microscope at a magnification of 200 and evaluated according to the criteria below.
O: No oligomer is determined.
x: A certain oligomer is determinable.

### (Appearance of Pressure-Sensitive Adhesive Layer)

Each sample was heated at 150° C. for 1 hour in a heating oven. The sample was then taken out and observed with a transmission microscope at a magnification of 200 and evaluated according to the criteria below.
O: No spherical foam is determined.
x: Spherical foams are determinable.

TABLE 1

| | | | | Evaluation | | |
|---|---|---|---|---|---|---|
| | Contents of Monomer | | | Determination of | | |
| | Units in Acrylic | | | Oligomer | | |
| | Polymer (wt %) | | | 150° C. for | 160° C. for | Appear- |
| | MA | BA | AA | 1 hour | 1 hour | ance |
| Example 1 | 5 | 93 | 2 | ∘ | x | ∘ |
| Example 2 | 18 | 80 | 2 | ∘ | ∘ | ∘ |
| Example 3 | 25 | 73 | 2 | ∘ | ∘ | ∘ |
| Example 4 | 30 | 68 | 2 | ∘ | ∘ | x |
| Compar- | 0 | 98 | 2 | x | x | ∘ |
| ative | | | | | | |
| Example 1 | | | | | | |

As shown in Table 1, no oligomer was observed in the pressure-sensitive adhesive layer of the electrically-conductive laminated film according to the invention. In the electrically-conductive laminated film according to the invention, the content of methyl acrylate is controlled so that spherical foams are also prevented in the pressure-sensitive adhesive layer.

1. An electrically-conductive laminated film, comprising:
a first transparent substrate having first and second surfaces;
an electrically-conductive film comprising a second transparent substrate having first and second surfaces and a transparent electrically-conductive thin layer provided on the first surface of the second transparent substrate; and
a pressure-sensitive adhesive layer,
wherein the first transparent substrate and the electrically-conductive film are arranged in such a manner that the second surface of the first transparent substrate is opposed to the second surface of the second transparent substrate,
wherein the first transparent substrate and the electrically-conductive film are bonded to each other with the pressure-sensitive adhesive layer interposed therebetween;
wherein each of the first and second transparent substrates each is formed of a plastic material,
wherein the pressure-sensitive adhesive layer is formed of a pressure-sensitive adhesive comprising an acrylic polymer comprising 1 to 35% by weight of a methyl (meth)acrylate monomer unit, 60 to 98% by weight of an alkyl (meth)acrylate monomer unit having an alkyl group of 2 to 12 carbon atoms, and 0.1 to 10% by weight of a functional group-containing monomer unit.

2. The electrically-conductive laminated film according to claim 1, wherein the acrylic polymer comprises 1 to 28% by weight of the methyl (meth)acrylate monomer unit, 65 to 98% by weight of the alkyl (meth)acrylate monomer unit having an alkyl group of 2 to 12 carbon atoms, and 0.1 to 10% by weight of the functional group-containing monomer unit.

3. The electrically-conductive laminated film according to claim 1, wherein the functional group-containing monomer is a carboxyl group-containing monomer.

4. The electrically-conductive laminated film according to claim 1, wherein the pressure-sensitive adhesive contains a crosslinking agent.

5. The electrically-conductive laminated film according to claim 1, wherein the pressure-sensitive adhesive contains a silane coupling agent.

6. The electrically-conductive laminated film according to claim 1, wherein the first transparent substrate comprises a hard coat layer provided on the first surface thereof.

7. The electrically-conductive laminated film according to claim 1, wherein the first and second transparent substrates are each formed of a polyester resin.

8. A touch panel electrode plate, comprising the electrically-conductive laminated film according to claim 1.

9. A touch panel, comprising a pair of touch panel electrode plates that each have a transparent electrically-conductive thin layer and are arranged opposite to each other with a spacer interposed therebetween in such a manner that the transparent electrically-conductive thin layers are opposed to each other, wherein at least one of the touch panel electrode plates is the touch panel electrode plate according to claim 8.

10. A pressure-sensitive adhesive for use in forming the pressure-sensitive adhesive layer of the electrically-conductive laminated film according to claim 1, comprising an acrylic polymer comprising 1 to 35% by weight of a methyl (meth)acrylate monomer unit, 60 to 98% by weight of an alkyl (meth)acrylate monomer unit having an alkyl group of 2 to 12 carbon atoms, and 0.1 to 10% by weight of a functional group-containing monomer unit.
